(19) United States
(12) Patent Application Publication
(10) Pub. No.: US 2007/0144130 A1
(43) Pub. Date: Jun. 28, 2007

(54) Hay-harvest machine provided with a hinged frame

(75) Inventor: Jens Geiser, Dettum-Allemagne (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: KUHN S.A., Saverne (FR)

(21) Appl. No.: 10/583,027

(22) PCT Filed: Dec. 14, 2004
(86) PCT No.: PCT/FR04/50687

§ 371 Date: Jun. 15, 2006

(30) Foreign Application Priority Data
Dec. 19, 2003 (FR) 0315016

(51) Int. Cl. A01D 34/00

(52) U.S. Cl. 56/14.9

(57) ABSTRACT

The inventive hay-harvest machine comprises a frame consisting of a longitudinal beam (2), a coupling device (3) which hinges on said beam (2) and by a cross member (4) which is fixed to the beam and provided with supporting wheels (7, 8). Said frame (1) comprises at least one working member for displacing products lied on the ground. Said invention is characterised in that the beam (2) of the frame (1) consists of at least two parts (21, 22) one of which carries the coupling device (3) and the other carries the cross member (4) provided with the wheels (7, 8) or with working members (13) and said parts (21, 22) are pivotable with respect to each other by means of at least one substantially vertical axis (23) in such a way that they swing with respect to each other, thereby making it possible to obtain different operating positions.

The present invention relates to a haymaking machine comprising a frame that consists of a longitudinal beam, a hitching device that is articulated on the beam by means of a substantially vertical axis, and by a crossmember that is attached to the beam and that carries soil resting wheels, which frame carries at least one work member capable of moving plants or other products lying on the ground.

A machine of this type is, for example, used for windrowing forage or moving and/or gathering windrows already formed together. This machine is then coupled to the rear of a tractor that makes it possible to drive its work members and move it on the ground. It frequently happens that, during the movement or the grouping of windrows, the tractor wheels run over the windrows that have to be picked up by the work members of the machine. These wheels then crush the forage, which can impair its quality. Specifically, under the pressure of the tyres, it can crumble and lose nutritional parts. It may also be soiled with earth after being pressed against the surface of the ground.

The object of the present invention is to overcome the aforementioned drawback.

It should in particular make it possible to ensure that the machine always follows an ideal work trajectory without the tractor wheels being obliged to run over the windrows.

Accordingly, an important feature of the invention consists in the longitudinal beam of the frame being made in at least two parts that are articulated with one another by means of at least one substantially vertical axis making it possible to move one of the parts relative to the other, the hitching device being articulated on the foremost part, the crossmember with the wheels and the work member or members being carried by the rearmost part and the work member or members being movable with said rear part about the substantially vertical axis of articulation into various working positions obtained by the pivoting of the front part about its axis of articulation with the hitching device.

This arrangement makes it possible to offset all the work members of the machine laterally relative to the median axis of the tractor. It is thus possible to cause the tractor wheels to run beside the windrows to prevent them being crushed, while keeping the work members of the machine in a good position relative to said windrows so that they can be picked up.

Another feature of the invention consists in at least one hydraulic cylinder being connected to each part of the longitudinal beam of the frame for the purpose of adjusting the position of the machine relative to the median axis of the tractor.

According to another feature of the invention, the machine comprises a mechanism for controlling the soil resting wheels that extends from the hitching device to said wheels and that comprises an articulation at the axis of articulation between the two parts of the beam of the frame. This mechanism makes it possible to control the soil resting wheels so that they perfectly follow the trajectory of the tractor in all the positions that it may occupy relative to said tractor.

Other features and advantages of the invention will emerge from the following description that refers to the appended drawings which represent, as a nonlimiting example, an embodiment of the machine according to the invention.

In these drawings:

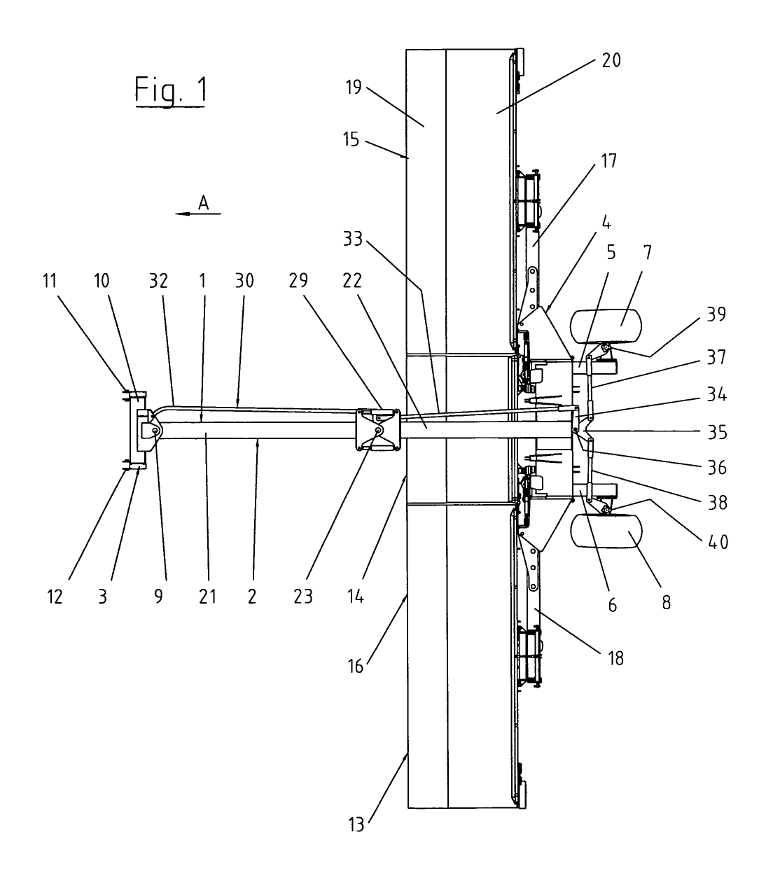

FIG. 1 represents a top view of a machine according to the invention in a first working position,

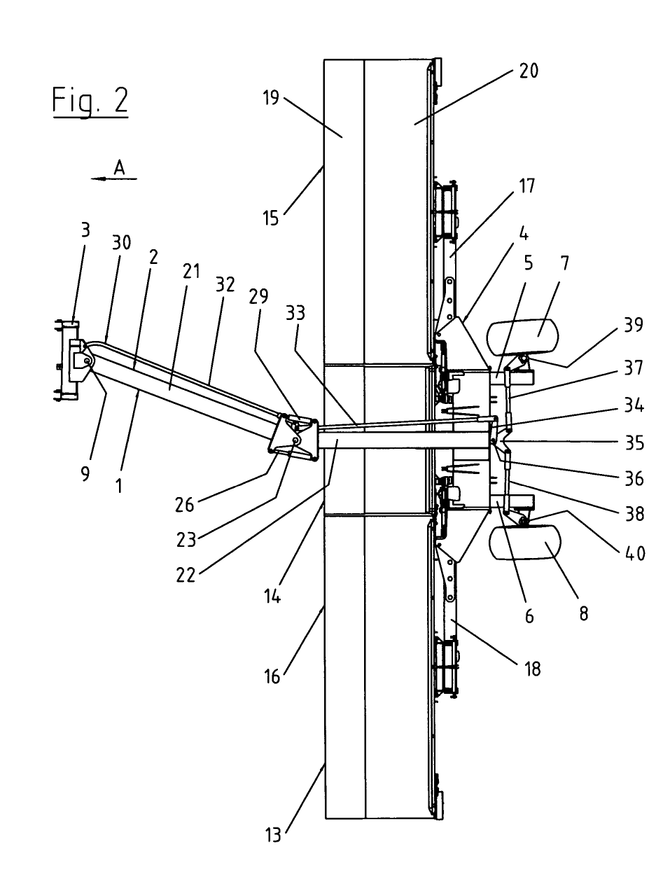

FIG. 2 represents a top view of the machine according to the invention in another working position,

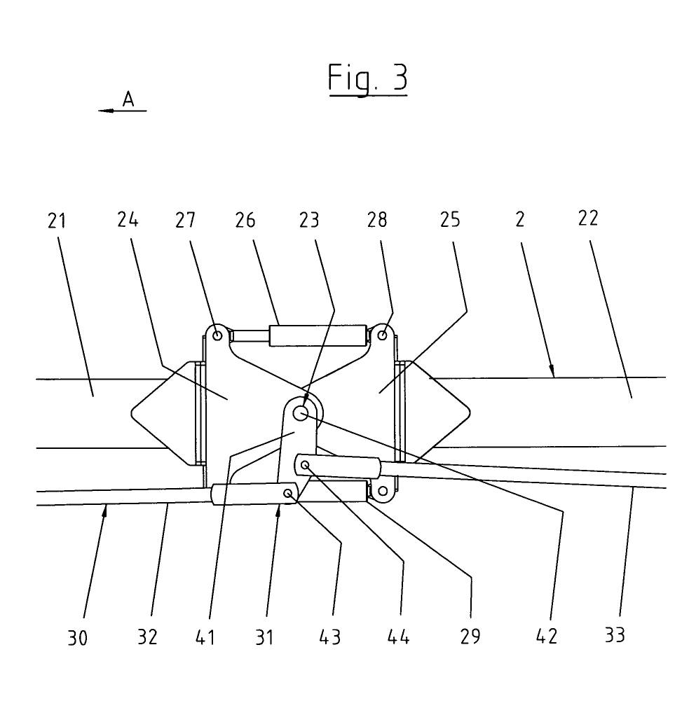

FIG. 3 represents, on a larger scale, a detail view of the articulation between two parts of the beam of the frame of the machine.

As represented in FIGS. 1 and 2, the machine according to the invention comprises a frame (1) that consists of a longitudinal beam (2), a hitching device (3) and a crossmember (4) that is provided with arms (5 and 6) carrying soil resting wheels (7 and 8). The hitching device (3) is articulated on the front end of the beam (2) by means of a substantially vertical axis (9). It consists of a substantially horizontal bar (10) provided with two points (11 and 12) for coupling to a tractor making it possible to drive and move the machine in the direction of travel (A). The crossmember (4) is attached to the rear end of the beam (2).

The frame (1) supports work members (13) capable of moving plants or other products lying on the ground. In the example shown, these work members (13) consist of a central pick-up and movement assembly (14) that is connected to the crossmember (4) and two side pick-up and movement assemblies (15 and 16). These side assemblies (15 and 16) are supported by arms (17 and 18) that are also connected to the crossmember (4). Each of these assemblies (14, 15, 16) consists of a pick-up (19), which picks up the products lying on the ground, and of a conveyor belt (20) which receives said products and moves them laterally. The direction of movement of these conveyor belts (20) is advantageously modifiable. The products may thus be moved to either side of the machine in order to form windrows or to gather windrows together. These pick-ups (19) and conveyor belts (20) may be driven mechanically or hydraulically from the tractor.

The work members (13) may be different from those described hereinabove. They may therefore also consist of one or more windrowing rotors of the type that can be driven in rotation about a substantially vertical axis and that comprise fork carrier arms.

The beam (2) of the frame (1) is made in at least two parts (21 and 22) situated one behind the other, the foremost part (21) carrying the hitching device (3) and the rearmost part (22) carrying the crossmember (4) with the wheels (7 and 8) and the work member or members (13). These two parts (21 and 22) are articulated with one another by means of at least one substantially vertical axis (23) which makes it possible to pivot one part relative to the other. Accordingly, the ends adjacent to said parts (21 and 22) are made in the form of devises (24 and 25) through which the axis of articulation (23) passes (see FIG. 3).

The two parts (21 and 22) of the beam (2) are also connected together by means of at least one hydraulic cylinder (26) making it possible to move the rear part (22) with all the work members (13) relative to the front part (21) about the axis of articulation (23) into different working positions obtained by the pivoting of the front part (21) about its axis of articulation (9) with the hitching device (3). This hydraulic cylinder (26) is offset laterally relative to said axis of articulation (23). It is itself articulated on said parts (21 and 22) of the beam (2) by means of axes (27 and 28) that are substantially parallel to the axis of articulation (23) between the two parts (21 and 22). In the case of the use of a single hydraulic cylinder (26), the latter is preferably double-acting.

As shown in FIGS. 1 to 3, a second hydraulic cylinder (29) may connect the two parts (21 and 22) of the beam (2) together. In this case, one of the hydraulic cylinders (26, 29) is situated on the right and the other on the left of the axis of articulation (23). These two hydraulic cylinders (26 and 29) may advantageously be single-acting.

A mechanism (30) for controlling the soil resting wheels (7 and 8) extends from the hitching device (3) to said wheels (7 and 8) in order to make them follow the trajectory of the tractor in the various positions of the machine. This mechanism (30) comprises an articulation (31) at the axis of articulation (23) between the two parts (21 and 22) of the beam (2). It consists of a first rod (32) that is articulated on the hitching device (3) and a second rod (33) that is connected to a lever (34) rigidly fastened to a pivot (35) that is articulated on the second part (22) of the beam (2) or on the crossmember (4) by means of a substantially vertical axis (36). This pivot (35) is connected by means of a third rod (37) and a fourth rod (38) to levers rigidly fastened to pivots (39 and 40) that are connected to the arms (5 and 6) and that carry the soil resting wheels (7 and 8). Said pivots (39 and 40) can be moved in horizontal planes, with the aid of the rods (37 and 38) in order to modify the orientation of the soil resting wheels (7 and 8) relative to the frame (1).

The articulation (31) between the first rod (32) and the second rod (33) comprises a lever (41) that is articulated on an axis (42) concentric with the axis of articulation (23) between the two parts (21 and 22) of the beam (2). Each of said rods (32 and 33) is articulated on this lever (41) by means of an axis (43 and 44) substantially parallel to the axis (42) of the lever (41). This arrangement allows the two rods (32 and 33) to follow the two parts (21 and 22) of the beam (2) when the relative position between the latter is modified by pivoting about the axis (23) with the aid of the hydraulic cylinders (26 and 29).

During work, the machine is hitched to a tractor that makes it possible to drive and move it in the direction of travel (A). The assemblies (14, 15 and 16) for picking up and moving the products are then lowered to the ground and are situated substantially on a line perpendicular to the direction of travel (A). Their pick-ups (19) are driven so that they pick up the products such as plants lying on the ground and place them on the conveyor belts (20). The latter are driven so that they move these products laterally, transmit them from one to the other and place them on one of the sides of the machine in the form of a large volume windrow.

In the case where the work members (13) consist of windrowing rotors, the latter are lowered to the ground and are driven in rotation so that their forks pick up and move the products. If the machine comprises several rotors, they may form individual windrows or a common central or side windrow.

In the first working position that is shown in FIG. 1, the two parts (21 and 22) of the beam (2) are substantially aligned and the machine is centered relative to the tractor. In a straight line, the machine faithfully follows the tractor. When the tractor turns, for example to travel round a corner, the hitching device (3) pivots about the axis of articulation (9) which connects it to the beam (2). Simultaneously, said hitching device (3), depending on whether it pivots to the right or to the left, pushes or pulls on the first rod (32). The latter transmits the movement by means of the lever (41) to the second rod (33) which causes the pivot (35) to rotate on the axis (36). This pivot (35) then actuates the rods (37 and 38) which move the pivots (39 and 40) with the wheels (7 and 8) in the direction opposite to that taken by the tractor. Said wheels (7 and 8) thus substantially follow the trajectory of the tractor wheels, which makes it possible to pick up and move all the products that are lying on the ground.

To prevent the tractor wheels from running over the products to be picked up, particularly when the latter are already in small windrows, the machine may be offset relative to the tractor. Such a position is represented in FIG. 2. This position is obtained by actuating the hydraulic cylinders (26 and 29) so that they move the rear part (22) of the beam (2) about the axis of articulation (23) so that it forms an angle other than 180° with the front part (21). During this pivoting action, the control device (30) actuates the pivots (39 and 40) with the soil resting wheels (7 and 8) so that the latter remain parallel to the rear part (22). Accordingly, when traveling forward, the wheels (7 and 8) steer this rear part (22) that supports the work members (13) in the direction of travel (A) while the front part (21) pivots about the axis of articulation (9) with the hitching device (3) and adopts an oblique position which ensures the sought-after lateral offset of the work members (13) of the machine relative to the tractor. The latter may then run beside the windrows while the work members (13) remain correctly positioned relative to the products to be picked up. Said offset may be increased or decreased by causing the angle between the two parts (21 and 22) of the beam (2) to vary by means of the hydraulic cylinders (26 and 29). In this offset working position, the control device (30) steers the soil resting wheels (7 and 8) in the same manner as in the position described hereinabove in order to optimize the quality of work.

For transport, the machine is brought into line with the tractor and the work members (13) may be raised and folded in order to move them away from the ground and reduce the width of the machine.

It is evident that the invention is not limited to the embodiment described and represented in the appended drawings. Modifications remain possible, particularly with respect to the constitution of the various elements or by substitution of technical equivalents, without, for all that, departing from the field of protection.

1. A haymaking machine comprising a frame (1) that consists of
a longitudinal beam (2),
a hitching device (3) that is articulated on the beam (2) by means of a substantially vertical axis (9),
a crossmember (4) that is attached to the beam (2) and that carries soil resting wheels (7 and 8),
which frame (1) carries at least one work member (13) capable of moving plants or other products lying on the ground,
characterized in that
the beam (2) is made in at least two parts (21 and 22) that are situated one behind the other and that are articulated with one another by means of at least one substantially vertical axis (23) making it possible to move one of the parts (21, 22) relative to the other,
the hitching device (3) is articulated on the foremost part (21),
the crossmember (4) with the wheels (7 and 8) and the work member or members (13) are carried by the rearmost part (22) and
the work member or members (13) can be moved with said rear part (22) about the axis of articulation (23) into different work positions obtained by pivoting the front part (21) about its axis of articulation (9) with the hitching device (3).

2. The machine as claimed in claim 1, characterized in that at least one hydraulic cylinder (26, 29) is connected to each part (21 and 22) of the beam (2).

3. The machine as claimed in claim 2, characterized in that the hydraulic cylinder or cylinders (26, 29) are offset laterally relative to the axis of articulation (23) between the two parts (21 and 22) of the beam (2).

4. The machine as claimed in claim 3, characterized in that two single-acting hydraulic cylinders (26 and 29), situated one on the right and the other on the left of the axis of articulation (23), are connected to each part (21 and 22) of the beam (2).

5. The machine as claimed in claim 1, characterized in that it comprises a mechanism (30) for controlling the soil resting wheels (7 and 8) that extends from the hitching device (3) to said wheels (7 and 8) and that comprises an articulation (31) at the axis of articulation (23) between the two parts (21 and 22) of the beam (2).

6. The machine as claimed in claim 5, characterized in that the control mechanism (30) comprises a first rod (32) that is articulated on the hitching device (3) and a second rod (33) that is connected to a pivot (35) articulated on the frame (1) and to which are connected a third and a fourth rod (37 and 38) that steer the wheels (7 and 8), said first and second rods (32 and 33) being articulated one relative to the other at the axis of articulation (23) between the two parts (21 and 22) of the beam (2).

7. The machine as claimed in claim 6, characterized in that the first and second rods (32 and 33) are articulated on a lever (41) that is itself articulated on an axis (42) concentric with the axis of articulation (23) between the two parts (21 and 22) of the beam (2).
